(19) United States
(12) Patent Application Publication
(10) Pub. No.: US 2023/0388352 A1
(43) Pub. Date: Nov. 30, 2023

(54) TECHNIQUES FOR DETECTING CYBERSECURITY EVENTS BASED ON MULTIPLE SOURCES

(71) Applicant: Wiz, Inc., New York, NY (US)

(72) Inventors: Itamar GILAD, Tel Aviv (IL); Aviel FOGEL, Tel Aviv (IL); Udi REITBLAT, Tel Aviv (IL); Alon SCHINDEL, Tel Aviv (IL); Ami LUTTWAK, Binyamina (IL); Roy REZNIK, Tel Aviv (IL); Yinon COSTICA, Tel Aviv (IL)

(73) Assignee: Wiz, Inc., New York, NY (US)

(21) Appl. No.: 18/361,376

(22) Filed: Jul. 28, 2023

Related U.S. Application Data
(63) Continuation-in-part of application No. 18/162,412, filed on Jan. 31, 2023.
Application No. 18/162,412 is a continuation-in-part of application No. 18/045,046, filed on Oct. 7, 2022.
(60) Provisional application No. 63/267,368, filed on Jan. 31, 2022.

(51) Int. Cl. H04L 9/40

(52) U.S. Cl. CPC H04L 63/205; H04L 63/1416; H04L 63/1425; H04L 63/162

(57) ABSTRACT

A system and method for detecting a cybersecurity event based on multiple cybersecurity data sources is disclosed. The method includes: receiving data from a first cybersecurity source, the first cybersecurity source configured to generate data based on a resource deployed in a computing environment; receiving data from a second cybersecurity source, the second cybersecurity source configured to generate data based on the resource deployed in the computing environment, wherein the second cybersecurity source has a source type which is different from a source type of the first cybersecurity source; detecting a cybersecurity event on the resource based on data received from the first cybersecurity source and data received from the second cybersecurity source; and initiating a mitigation action for the resource in response to detecting the cybersecurity event.

### CROSS-REFERENCE TO RELATED APPLICATIONS

This application is continuation in part of U.S. patent application Ser. No. 18/162,412 filed Jan. 31, 2023, which itself claims the benefit of U.S. Provisional Patent Application No. 63/267,368 filed on Jan. 31, 2022. This application is also a continuation in part of U.S. patent application Ser. No. 18/045,046 filed Oct. 7, 2022. All contents of these applications are hereby incorporated by reference.

### TECHNICAL FIELD

The present disclosure relates generally to detection of cybersecurity threats, and specifically to complementary solutions for cybersecurity threat detection utilizing static analysis and runtime data.

### BACKGROUND

Cybersecurity threats come in many shapes and forms, such as malware, worms, cryptominers, man-in-the-middle attacks, code injection, misconfigurations, and so on. Different threats pose different risks, and can often be detected in different ways. As such, there are many solutions which detect different types of cybersecurity threats, each with advantages and disadvantages. Cloud computing platforms, such as provided by Amazon® Web Services (AWS), Google® Cloud Platform (GCP), Microsoft® Azure, and the like, are high value targets for attackers, and therefore their vulnerabilities are more likely to become cybersecurity threats. It is therefore extremely useful to detect such cybersecurity threats.

For example, agent based solutions are able to detect both runtime and stored data, allowing to form a complete picture of the cybersecurity status of a machine having the agent installed thereon. However, agent based solutions require heavy use of compute resources, such as processor and memory resources. This is due to the agent being deployed on the machine which is scanned. For endpoints in a network, this type of solution is impractical, as the use of those resources is reserved for performing the task of the endpoint machine. Furthermore, some agent solutions also require communication with a backend which provides definitions, rules, and the like, in order to enable the agent to scan for cybersecurity threats using up to date information. Additionally, some agent based solutions require root privileges, or are deployed as a privileged software container. This in itself is a security risk, as conveying such permissions is inherently risky. Therefore, as an endpoint detection and response (EDR) solution for a cloud computing production environment, agent based solutions fail at their objective, and indeed such solutions are rarely used on network endpoints due to the above mentioned reasons.

Agentless solutions, on the other hand, do not require an agent installed on a machine. These solutions include static analysis, for example of a disk of a machine, to determine what cybersecurity threats are present. However, such solutions likewise fail at providing a complete picture, since static analysis solutions do not have access to runtime data. Such agentless solutions also fail to provide real time threat detection, thereby potentially leaving cybersecurity threats with a response for prolonged periods of time.

Utilizing both types of solution is not practical, as there is overlap in the data of agent and agentless solutions, and the computational costs of deploying both solutions on a single network are great. This leads, in practice, to a choice between either type of solution, with the resignation that some threats will inevitably go undetected.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include receiving data from a first cybersecurity source, the first cybersecurity source configured to generate data based on a resource deployed in a computing environment. Method may also include receiving data from a second cybersecurity source, the second cybersecurity source configured to generate data based on the resource deployed in the computing environment, where the second cybersecurity source has a source type which is different from a source type of the first cybersecurity source. Method may furthermore include detecting a cybersecurity event on the resource based on data received from the first cybersecurity source and data received from the second cybersecurity source. Method may in addition include initiating a mitigation action for the resource in response to detecting the cybersecurity event. Other embodiments of this aspect include corresponding computer systems, apparatus, and computer programs recorded on one or more computer storage devices, each configured to perform the actions of the methods.

Implementations may include one or more of the following features. Method may include: receiving data from a plurality of cybersecurity sources, where at least a first cybersecurity source is of a first type, and a second cybersecurity source is of a second type which is different from the first type. Method may include: storing the received data in a graph database, the graph database including a security graph having stored therein a representation of the computing environment. Method may include: applying a policy to data received from the first cybersecurity source; and generating an instruction to receive data from the second cybersecurity source in response to triggering a rule of the policy. Method may include: detecting an event in the data received from the first cybersecurity source; and detecting a cybersecurity object in the data received from the second cybersecurity source. Method where the cybersecurity object is any one of: a file, a file system, a hash, a password, a certificate, an encryption key, a malware object, and a combination thereof. Method where the mitigation action includes any one of: sandboxing the resource on which the cybersecurity event is detected, revoking network access to the resource, revoking network access from the resource, generating an alert, generating a severity score for an alert, generating a notification, initiating inspection of a resource, and any combination thereof. Method may include: initiating inspection of the resource in response to detecting the cybersecurity event. Method where the received data includes any one of: an event record, a file, a hash, an identifier of a resource, an identifier of a principal, a timestamp, and any combination thereof. Implementations of the described techniques may include hardware, a method or process, or a computer tangible medium.

In one general aspect, non-transitory computer-readable medium may include one or more instructions that, when executed by one or more processors of a device, cause the device to: receive data from a first cybersecurity source, the first cybersecurity source configured to generate data based on a resource deployed in a computing environment; receive data from a second cybersecurity source, the second cybersecurity source configured to generate data based on the resource deployed in the computing environment, where the second cybersecurity source has a source type which is different from a source type of the first cybersecurity source. Medium may furthermore detect a cybersecurity event on the resource based on data received from the first cybersecurity source and data received from the second cybersecurity source. Medium may in addition initiate a mitigation action for the resource in response to detecting the cybersecurity event. Other embodiments of this aspect include corresponding computer systems, apparatus, and computer programs recorded on one or more computer storage devices, each configured to perform the actions of the methods.

In one general aspect, system may include a processing circuitry. System may also include a memory, the memory containing instructions that, when executed by the processing circuitry, configure the system to: receive data from a first cybersecurity source, the first cybersecurity source configured to generate data based on a resource deployed in a computing environment. System may in addition receive data from a second cybersecurity source, the second cybersecurity source configured to generate data based on the resource deployed in the computing environment, where the second cybersecurity source has a source type which is different from a source type of the first cybersecurity source. System may moreover detect a cybersecurity event on the resource based on data received from the first cybersecurity source and data received from the second cybersecurity source. System may also initiate a mitigation action for the resource in response to detecting the cybersecurity event. Other embodiments of this aspect include corresponding computer systems, apparatus, and computer programs recorded on one or more computer storage devices, each configured to perform the actions of the methods.

Implementations may include one or more of the following features. System where the memory contains further instructions which when executed by the processing circuitry further configure the system to: receive data from a plurality of cybersecurity sources, where at least a first cybersecurity source is of a first type, and a second cybersecurity source is of a second type which is different from the first type. System where the memory contains further instructions which when executed by the processing circuitry further configure the system to: store the received data in a graph database, the graph database including a security graph having stored therein a representation of the computing environment. System where the memory contains further instructions which when executed by the processing circuitry further configure the system to: apply a policy to data received from the first cybersecurity source; and generate an instruction to receive data from the second cybersecurity source in response to triggering a rule of the policy. System where the memory contains further instructions which when executed by the processing circuitry further configure the system to: detect an event in the data received from the first cybersecurity source; and detect a cybersecurity object in the data received from the second cybersecurity source. System where the cybersecurity object is any one of: a file, a file system, a hash, a password, a certificate, an encryption key, a malware object, and a combination thereof. System where the mitigation action includes any one of: sandboxing the resource on which the cybersecurity event is detected, revoking network access to the resource, revoking network access from the resource, generating an alert, generating a severity score for an alert, generating a notification, initiating inspection of a resource, and any combination thereof. System where the memory contains further instructions which when executed by the processing circuitry further configure the system to: initiate inspection of the resource in response to detecting the cybersecurity event. System where the received data includes any one of: an event record, a file, a hash, an identifier of a resource, an identifier of a principal, a timestamp, and any combination thereof. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of a cloud computing environment monitored for a cybersecurity threat by an inspection environment, implemented in accordance with an embodiment.

FIG. 2 is an example schematic illustration of a sensor backend server communicating with a plurality of sensors deployed on various workloads, implemented in accordance with an embodiment.

FIG. 3 is an example flowchart of a method for performing cybersecurity threat detection on a resource in a cloud computing environment, implemented in accordance with an embodiment.

FIG. 4 is an example of a network log of a cloud based computing environment, in accordance with an embodiment.

FIG. 5 is an example of a role log of a cloud computing environment, utilized to describe an embodiment.

FIG. 6 is another example of a role log of a cloud based computing environment, utilized to describe an embodiment.

FIG. 7 is an example of a security graph, implemented in accordance with an embodiment.

FIG. 8 is a flowchart of a method for generating a cloud detection and response (CDR) alert based on cloud log and a security graph, implemented in accordance with an embodiment.

FIG. 9 is an example flowchart of a method for detecting a cybersecurity threat based on multiple information sources, implemented in accordance with an embodiment.

FIG. 10 is an example schematic diagram of an inspection controller according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for detecting cybersecurity threats from multiple sources. According to an embodiment, static analysis detection techniques are combined with data detected in runtime from a virtual workload deployed in a cloud computing environment, to ascertain if a cybersecurity threat, vulnerability, misconfiguration, exposure, and the like, are present on the virtual workload.

For example, according to an embodiment, a virtual workload is inspected for a cybersecurity object, and a sensor deployed on the virtual workload is configured to listen on a data link layer of the virtual workload to detect events which indicate that the cybersecurity object poses a cybersecurity risk.

In an embodiment, the data link layer is also known as layer 2 of the OSI model of computer networking. In some embodiments, the data link layer is configured to transfer frames, which are containers for network packets. For example, Ethernet™, Frame Relay, PPP, USB, PCI Express, and the like, are protocols for data link layer communication. In TCP/IP, the data link layer is the lowest layer, known as the link layer.

This is advantageous as it allows to detect cybersecurity threats which are present on a virtual workload and additionally actually posing a threat, as opposed to a cybersecurity vulnerability which is present but is not currently being exploited. This allows remediation and mitigation actions to be prioritized to such workloads.

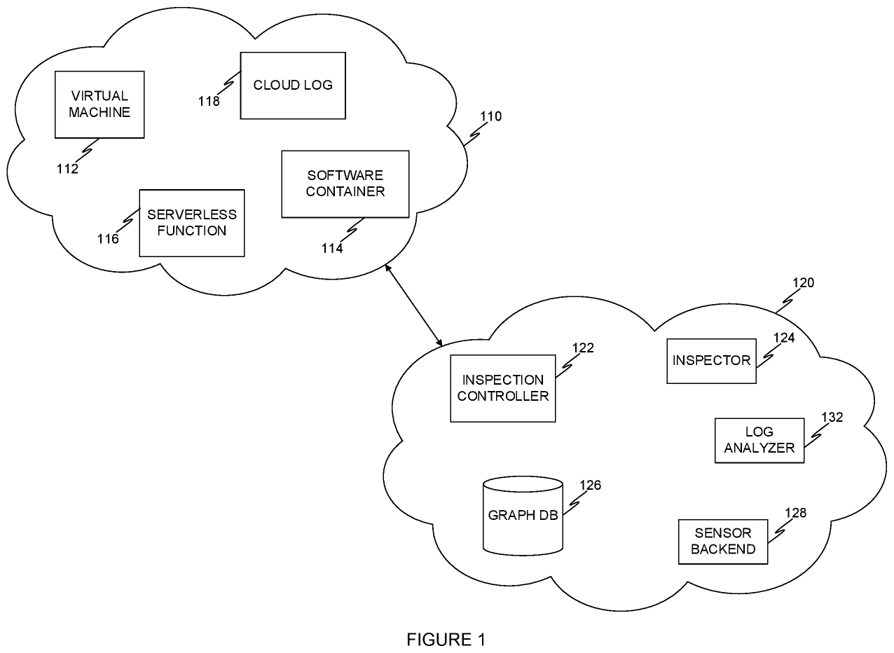

FIG. 1 is an example schematic diagram of a cloud computing environment monitored for a cybersecurity threat by an inspection environment, implemented in accordance with an embodiment. In an embodiment, a cloud computing environment 110 is implemented as a virtual private cloud (VPC), Virtual Network (VNet), and the like, over a cloud computing infrastructure. A cloud computing infrastructure is provided, for example, by Amazon® Web Services (AWS), Google® Cloud Platform (GCP), Microsoft® Azure, and the like, according to some embodiments. In an embodiment, a cloud computing environment 110 includes cloud entities deployed therein. In certain embodiments, a cloud entity is, for example, a principal, a resource, a combination thereof, and the like. In an embodiment, a resource is a cloud entity which provides access to a compute resource, such as a processor, a memory, a storage, and the like. In some embodiments a resource is a virtual machine, a software container, a serverless function, and the like. According to an embodiment, a resource is, or includes, a software application deployed thereon, such as a webserver, a gateway, a load balancer, a web application firewall (WAF), an appliance, and the like.

In certain embodiments, a principal is a cloud entity which is authorized to initiate actions in the cloud computing environment. A cloud entity is, for example, according to an embodiment, a user account, a service account, a role, and the like. In some embodiments, a cloud entity is a principal relative to another cloud entity, and a resource to other cloud entities. For example, a load balancer is a resource to a user account requesting a webpage from a webserver behind the load balancer, and the load balancer is a principal to the webserver.

In an embodiment, the cloud computing environment 110 includes a plurality of resources, such as virtual machine 112, software container 114, and serverless function 116. In some embodiments, a virtual machine 112 is deployed, for example, utilizing Oracle® VirtualBox®. In certain embodiments, a software container 114 is deployed, for example, utilizing a Docker® engine, a Kubernetes® platform, and the like. In an embodiment, a software container 114 is configured to deploy a software container cluster, each cluster including a plurality of nodes. In an embodiment, a node includes a plurality of pods. According to an embodiment, a serverless function 116 is, for example, utilized with Amazon® Lambda. In an embodiment, the serverless function 116 is a serverless function container image.

Each such resource is susceptible to various cybersecurity threats. Such threats can become apparent for example due to a software version of an application in a software container 114, an operating system (OS) version of a virtual machine 112, a misconfiguration in code of a serverless function 116, and the like. The cloud computing environment 110 is monitored for cybersecurity threats by an inspection environment 120. In an embodiment, the inspection environment 120 is implemented as a cloud computing environment, such as a VPC, VNet, and the like. In some embodiments, the inspection environment 120 includes various data sources, each configured to monitor different aspects of the cloud computing environment 110. For example, the inspection environment 120 is configured, according to an embodiment, to provide cloud detection and response (CDR) monitoring solutions, external attack surface management (EASM) monitoring solutions, active inspection, combinations thereof, and the like.

In some embodiments, cloud entities, resources, principals, and the like, are configured to generate activity which is logged in a network log 118. A network log 118 is implemented, according to an embodiment, as a file that contains events (also referred to as data records), which correspond to actions by one or more applications. In an embodiment, an event is, for example, a user call to an object in the cloud computing environment 110, a process call to an object, an authentication attempt, an access request, and the like.

In an embodiment, a service, for example implemented as a serverless function 116, is configured to write events to a network log 118 (which is a type of cloud log). In certain embodiments, the service is configured to monitor a resource in the cloud computing environment 110 and write events to the network log 118. In an embodiment, an event is added to the network log 118 as a record, for example based on a predetermined data structure. In some embodiments, the network log is implemented, for example, using CloudTrail®.

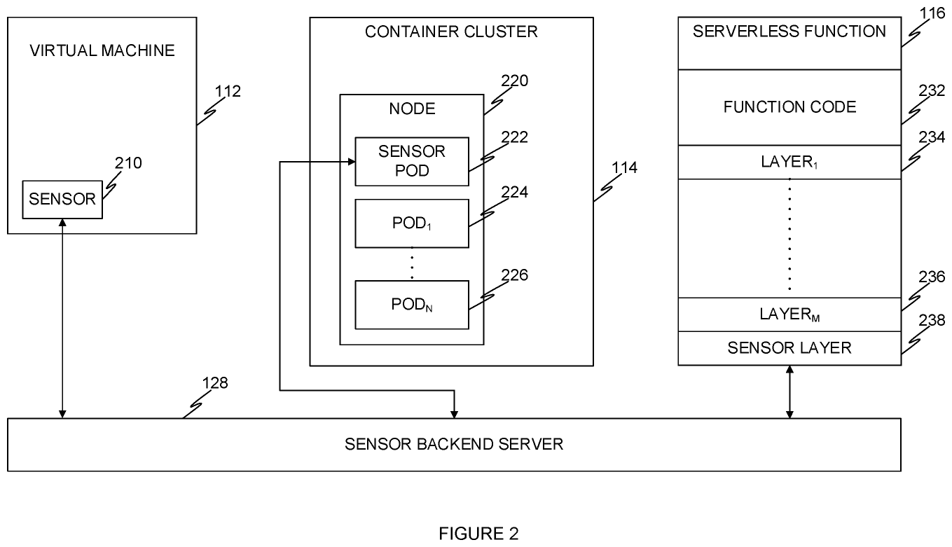

In an embodiment, each of the virtual machine 112, the software container 114, and the serverless function 116 include a sensor configured to a particular resource, resource type, combination thereof, and the like. An example deployment of a sensor is discussed in more detail in FIG. 2 below.

In an embodiment, the sensor (not shown in FIG. 1) is configured to listen for events, packets, and the like, on a data link layer. For example, the sensor is configured to utilize an eBPF interface, which allows non-intrusive monitoring of the data link layer communication, according to an embodiment. In certain embodiments, the sensor is further configured to send data to and receive data from a sensor backend server 128. According to an embodiment, the sensor backend server 128 is a workload, such as a virtual machine, software container, serverless function, combination thereof, and the like, which is deployed in the inspection environment 120.

In an embodiment, the sensor backend server 128 is configured to receive sensor generated data. For example, the sensor backend server 128 is configured, in an embodiment, to receive events from a sensor. In some embodiments, the sensor is configured to request from the sensor backend server 128 rules, definitions, and the like, which the sensor is configured to apply to events, for example as detected on an eBPF interface.

For example, in an embodiment, a predetermined event, such as indicating access to an IP address, IP address range, and the like, is checked against a definition. A definition is a logical expression which, when applied to an event, yields a “true” or “false” result. In an embodiment, a rule is a logical expression which includes an action. For example, a rule may be that if a certain definition is true when applied to an event, data pertaining to the event should be sent to the sensor backend server 128.

In some embodiments, the sensor backend server 128 is configured to initiate inspection of a resource deployed in the cloud computing environment 110. For example, in an embodiment, the sensor backend server 128 is configured to initiate such inspection in response to receiving an event, data, a combination thereof, and the like, from a sensor deployed on a resource. In an embodiment, initiating inspection of a resource is performed by generating an instruction for an inspection controller 122. The instruction, when executed, configures an inspector 124 to inspect the resource.

For example, a sensor is configured to send event data to the sensor backend server 128 in response to detecting that a definition, applied by the sensor to a detected event, results in a “true” value when applied. As an example, the definition may be “is the IP address in the range of 127.0.0.1 through 127.0.0.99”, which in this example correspond to an IP address range used by a malware, such as a cryptominer. When the definition is applied, for example to a detected network packet, and the result is “true”, the sensor is configured to send data pertaining to the event to the sensor backend server 128. Data pertaining to the event is, for example, an IP address, an event type, combinations thereof, and the like, according to some embodiments.

In an embodiment, the sensor backend server 128 is configured to receive the data. In some embodiments, the sensor backend server 128 is further configured to apply a rule to the received data to determine if an inspection of the workload on which the sensor is deployed should be inspected for a cybersecurity threat. For example, in an embodiment, the sensor backend server 128 is configured to generate an instruction to inspect a virtual machine 112, in response to receiving an indication from a sensor deployed as service on the virtual machine that a communication has been detected between the virtual machine 112 and a server having an IP address which is a forbidden IP address, such as an IP address associated with a malware.

For example, the sensor backend server 128 may generate an instruction for the inspection controller 122, which when executed by the inspection controller generates a an inspectable disk, for example utilizing a snapshot, a copy, a clone, and the like of a disk (not shown) associated with the virtual machine 112, and provides access to an inspector 124 to the inspectable disk. In an embodiment the inspector 124 is configured to detect a cybersecurity threat. For example, the inspector 124 is configured to receive, in an embodiment, a hash of an application stored on the inspectable disk, and determine if the hash matches a hash of known malware applications. In certain embodiments, the inspector 124 is provided with a persistent volume claim (PVC) to the inspectable disk.

In some embodiments, the sensor is configured to generate a hash of an application on the resource, such as the virtual machine 112, on which it is deployed, and send the hash to the sensor backend server 128. The received hash may then be compared, for example by providing it to the inspector 124, with known hash values which correspond to malware applications.

While the examples above discuss malware and cryptominers, it is readily apparent that the sensor and inspector 124 may be utilized to detect other types of cybersecurity threats, such as an exposure, a vulnerability, a weak password, an exposed password, a misconfiguration, and the like, according to various embodiments.

In certain embodiments, the inspection environment 120 further includes a graph database 126, on which a security is stored. In some embodiments, the graph database is implemented using, for example, Neo4j®. In an embodiment, the security graph is configured to store a representation of a cloud computing environment, such as cloud computing environment 110. For example, in an embodiment, the representation is based on a predefined unified data schema, so that each different cloud platform may be represented using a unified data schema, allowing for a unified representation. For example, a principal is represented by a predefined data structure, each principal represented by a node in the security graph, according to an embodiment. Likewise, in an embodiment, a resource is represented by another predefined data structure, each resource represented by a node in the security graph.

In certain embodiments, data received from a sensor deployed on a resource in the cloud computing environment may be stored in the graph database as part of the security graph. In the example above, in response to receiving data from the sensor which indicates a potential malware infection of the virtual machine 112, the sensor backend server 128 is configured, in an embodiment, to: generate a node representing the malware in the security graph, generate a node in the security graph representing the virtual machine 112, and connect the node representing the malware with the node representing the virtual machine 112.

In certain embodiments, the inspection environment 120 includes a log analyzer 132. In an embodiment, the log analyzer 132 is implemented as a workload, such as a node in a software container. According to an embodiment, the log analyzer 132 is configured to access cloud logs, network logs, the graph database 126, and the like. In an embodiment, the log analyzer 132 is configured to generate an alert based on detecting a cybersecurity event in any one of: a cloud log, a network log, a role log, a security graph, a combination thereof, and the like.

In certain embodiments, the alert includes, for example, a portion extracted from a cloud log, a portion extracted from a network log, a portion extracted from a role log, a combination thereof, and the like, wherein the extracted portion is based on a node from the security graph.

In some embodiments, the inspection controller 122 is configured to receive data from the inspector 124, the sensor backend server 128, the log analyzer 132, and the like. In certain embodiments, a cybersecurity event is detected based on data combined from multiple sources, e.g., from the inspector 124, a sensor deployed on a resource, the log analyzer 132, and the like. This is advantageous, as each data source provides different information about the cloud computing environment 110 and the resources deployed therein.

For example, in an embodiment, a first event is detected by a log analyzer 132 which is not indicative of a cybersecurity event on its own. Further, a second event, for example of a second type, is detected by a sensor, which likewise is not indicative on its own of a cybersecurity event. However, when cross-referenced, the two events, each detected utilizing a different data source, indicate together that a cybersecurity event occurred. For example, in an embodiment, the log analyzer 132 is configured to detect a generated principal. In the example embodiment, a sensor deployed on the virtual machine 112 detects a data packet transfer which is initiated by the newly generated principal. The inspector 124 is configured to detect a misconfiguration on the virtual machine 112, which allows the principal to access the virtual machine 112. Therefore, in the example embodiment, while each of the events on their own does not indicate a cybersecurity event, when combined the events indicate together that a cybersecurity event has occurred, namely that a newly formed principal is accessing a resource which they should not have access to, and is transferring data from the resource to another destination.

FIG. 2 is an example schematic illustration of a sensor backend server communicating with a plurality of sensors deployed on various workloads, implemented in accordance with an embodiment. In some embodiments, a sensor backend server 128 is configured to communicate with a machine having a sensor installed thereon and communicatively coupled with the sensor backend server 128. In an embodiment, the machine is a bare metal machine, a computer device, a networked computer device, a laptop, a tablet, and the like computing devices.

In an embodiment, a sensor backend server 128 is implemented as a virtual machine, a software container, a serverless function, a combination thereof, and the like. In certain embodiments, a plurality of sensor backend servers 128 are implemented. In some embodiments where a plurality of sensor backend servers 128 are utilized, a first group of sensor backend servers of the plurality of sensor backend servers is configured to communicate with a sensor deployed on a first type of resource (e.g., virtual machine), a second group of sensor backend servers is configured to communicate with resources of a second type, etc. In an embodiment, a first group of sensor backend servers is configured to communicate with sensors deployed on resources in a first cloud computing environment deployed on a first cloud platform (e.g., AWS) and a second group of sensor backend servers is configured to communicate with sensors deployed on resources in a second cloud computing environment deployed on a second cloud platform (e.g., GCP).

A virtual machine 112 (i.e., the virtual machine 112 of FIG. 1) includes a sensor 210. In an embodiment, the sensor 210 is deployed as a service executed on the virtual machine 112. In some embodiments, a virtual machine 112 is configured to request binary code, a software package, and the like, for example from a sensor backend sever 128, which when executed by the virtual machine 112 cause a sensor 210 to run as a service on the virtual machine 112. The sensor 210 is configured to listen to a data link layer communication, for example through an eBPF interface.

A container cluster 114 runs a daemonset, and includes a plurality of nodes, such as node 220, according to an embodiment. The daemonset ensures that each node 220 runs a daemonset pod 222, which is configured as a sensor. For example, a Kubernetes® cluster may execute a daemonset configured to deploy a daemonset pod on each deployed node, wherein the daemonset pod is configured to listen to a data link layer communication, for example through an eBPF interface, to communication of a plurality of pods, such as pod-1 224 through pod-N 226, where ‘NI’ is an integer having a value of ‘1’ or greater. The daemonset pod 222 is configured, in an embodiment, to communicate with the sensor backend server 128.

A serverless function 116 includes, in an embodiment, a function code 232, and a plurality of code layers 1 through M (labeled respectively as 234 through 236), where CM′ is an integer having a value of ‘1’ or greater. For example, in AWS Lambda a layer contains, in an embodiment, code, content, a combination thereof, and the like. In some embodiments, a layer, such as layer 234 includes runtime data, configuration data, software libraries, and the like.

In certain embodiments, the serverless function 116 includes a sensor layer 238. The sensor layer 238 is configured, in an embodiment, to listen to a data link layer communication of the serverless function 116, for example through an eBPF interface.

The sensor service 210, daemonset pod 222, and sensor layer 238 are each an implementation of a sensor, according to an embodiment. In an embodiment, a sensor is configured to communicate with a sensor backend server 128 through a transport layer protocol, such as TCP. For example, the sensor backend server 128 is configured, in an embodiment, to listen to a predetermined port using a TCP protocol, and a sensor, such as sensor 210, daemonset pod 222, and sensor layer 238 are each configured to communicate with the backend sensor server 128, for example by initiating communication using TCP over the predetermined port.

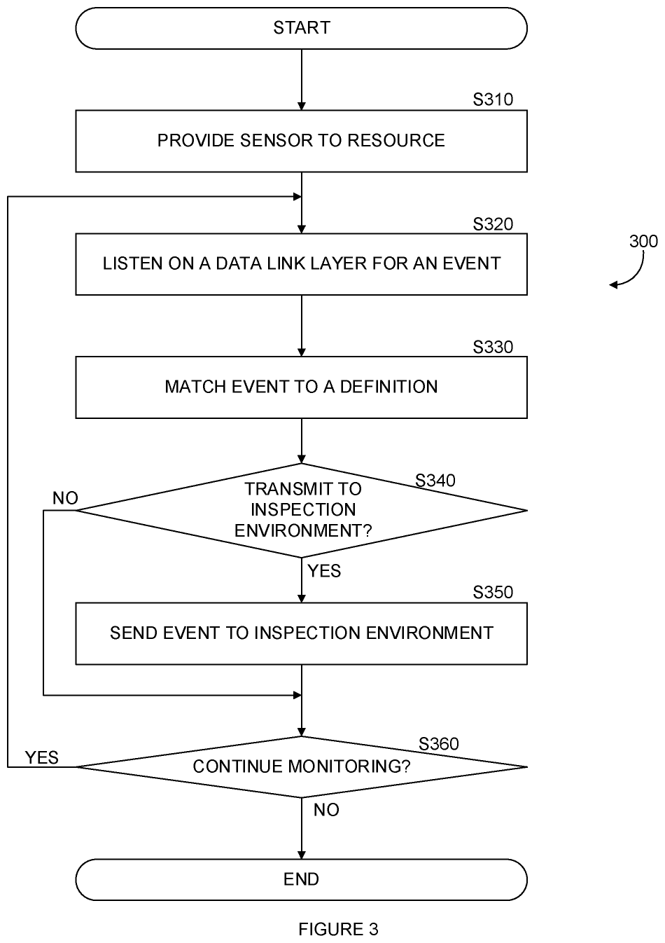

FIG. 3 is an example flowchart 300 of a method for performing cybersecurity threat detection on a resource in a cloud computing environment, implemented in accordance with an embodiment.

At S310, a resource is provided with a sensor software. In an embodiment, the resource is any one of a virtual machine, a software container, a serverless function, and the like. In certain embodiments, the sensor software is provided based on the resource type. For example, a virtual machine is provided with a software package, such as an executable code, for example a binary code. A software container engine is provided with a daemonset, so that, in an embodiment where a node is deployed in a cluster of the software container engine, the node includes a daemonset pod which is configured to provide the functionality of a sensor, for example such as detailed above. In an embodiment, a serverless function is provided with a sensor layer by providing a code for example in a .ZIP file.

In an embodiment, providing a sensor includes configuring a resource, such as a virtual machine, software container, serverless function, and the like, to receive software which, when executed, configures the resource to deploy a sensor thereon.

At S320, an event is detected from a data link layer communication. In an embodiment, the data link layer is monitored through an eBPF interface for events. In certain embodiments, a software bill of materials (SBOM) is generated. An SBOM may be implemented as a text file, which is based off of events which were detected, for example through the eBPF interface. In an embodiment, an SBOM includes an identifier of a library which is accessed in runtime, an identifier of a binary which is accessed in runtime, an image of which an instance is deployed in runtime, a port which is accessed by a runtime program, a cryptographic hash function value (such as an SHA1, SHA2, and the like values), and the like. For example, an SBOM may include:

```
programs {
  exe_name: ″/usr/sbin/rpc.mountd″
  last_seen: 1663138800
  exe_size: 133664
  exe_sha1: ″200f06c12975399a4d7a32e171caabfb994f78b9″
  modules {
    path: ″/usr/lib/libresolv-2.32.so″
    last_seen: 1663138800
  }
  modules {
    path: ″/usr/lib/libpthread-2.32.so″
    last_seen: 1663138800
  }
  modules {
    path: ″/usr/lib/ld-2.32.so″
    last_seen: 1663138800
  }
  modules {
    path: ″/usr/lib/libc-2.32.so″
    last_seen: 1663138800
  }
  modules {
    path: ″/usr/lib/libtirpc.so.3.0.0″
    last_seen: 1663138800
  }
  modules {
    path: ″/usr/lib/libnss_files-2.32.so″
    last_seen: 1663138800
  }
  modules {
    path: ″/usr/sbin/rpc.mountd″
    last_seen: 1663138800
  }
  listening_sockets {
    ip_addr: ″0.0.0.0″
    port: 60311
  }
  listening_sockets {
    ip_addr: ″0.0.0.0″
    port: 43639
  }
```

This portion of an SBOM indicates that a remote procedure call (RPC) is executed, which is configured to receive a client request to mount a file system.

At S330, the event is matched to a definition. In some embodiments, a definition includes a logical expression, which when applied to an event results in a “true” or “false” value. For example, a definition may state “software library xyz is accessed”, with a result being either true or false, when applied to an event. In some embodiments, a rule is applied to an event. In an embodiment, a rule is a logical expression which further includes an action. For example, a rule states, in an embodiment, “IF software library xyz is accessed by UNKNOWN SOFTWARE, generate an alert”. In this example, where an event is detected in which a software having an unknown identifier, for example which does not match a list of preapproved identifiers, attempts to access software library xyz, an alert is generated to indicate that such access is performed.

At S340, a check is performed to determine if data should be transmitted to an inspection environment. In some embodiments, the check is performed by applying a rule to an event, and determining transmission based on an output of applying the rule. If ‘yes’, execution continues at S350, if ‘no’ execution continues at S360.

At S350, data respective of an event is transmitted to an inspection environment. In an embodiment, the data is based on an SBOM file. In some embodiments, the data includes event data, such as an identifier of a resource (e.g., virtual machine, software container, serverless function, etc.), an identifier of an application, a hash value, a uniform resource locator (URL) request, a software library identifier, a software binary file identifier, a timestamp, and the like.

At S360, a check is performed to determine if monitoring of the resource should continue. For example, a daemonset of a container may be configured to periodically deploy a daemonset pod to monitor pods in a node. As another example, a virtual machine may be configured to periodically deploy a sensor service which runs as a process on the virtual machine, terminate the process after a predetermined period of time, terminate the process after a predetermined number of detected events, and the like. In some embodiments, the check is performed based on a predetermined amount of elapsed time (e.g., every four hours, every day, twice a day, etc.). If ‘yes’, execution continues at S320. If ‘no’, in an embodiment execution terminates. In some embodiments, if ‘no’, another check is performed at S360, for example after a predetermined period of time has lapsed.

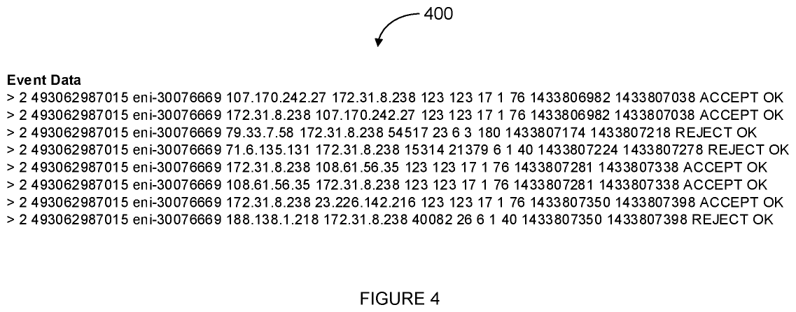

FIG. 4 is an example of a network log 400 of a cloud based computing environment, in accordance with an embodiment. In an embodiment, a network log 200 (a type of cloud log) includes a plurality of events, each event recorded as a row in the log. According to some embodiments, a record includes a plurality of data fields and their values. In an embodiment, an order of a plurality of data fields corresponds to a data structure. In certain embodiments, a data field is, for example, an account identifier, an interface identifier, a source address and a destination address (for network messages), a port, a protocol, a number of bytes transferred, a number of packets transferred, an action (e.g. accept, reject, etc.), a combination thereof, and the like.

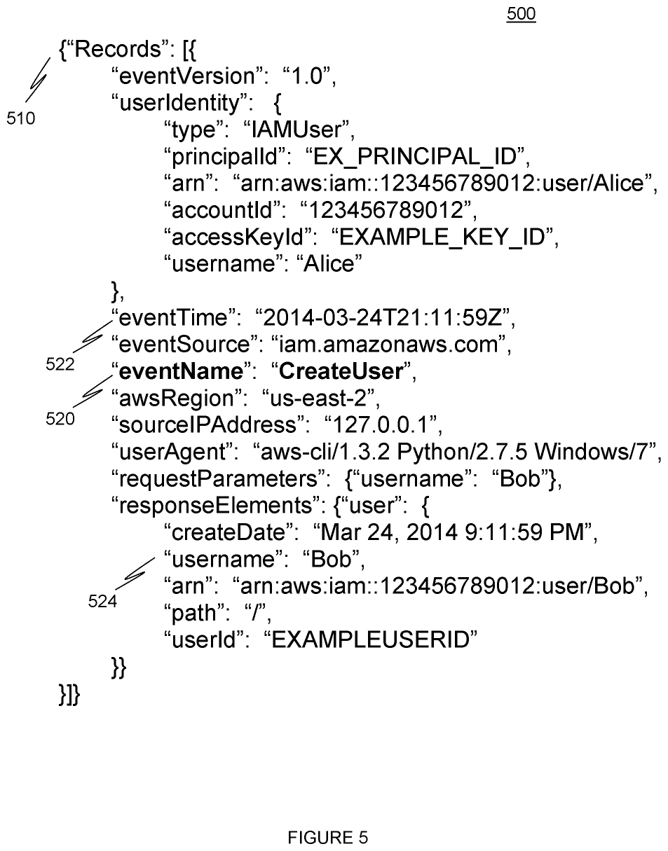

FIG. 5 is an example of a role log 500 of a cloud computing environment, utilized to describe an embodiment. In an embodiment, a role log includes data records which relate to events based on identifiers of principals. In certain embodiments, the role log 500 includes records generated based on events which are associated with user accounts, service accounts, roles, and the like.

For example, according to an embodiment, a first record 510 includes an event by which a new user account was created. The first record 510 includes a plurality of data fields, each data field having a value. In some embodiments, the data field values are unique to an event. For example, the event has an event name 520, which indicates that the event is related to creating a user account, at an event time 522. Other identifiers, such as the username 524 of the created user account are also recorded.

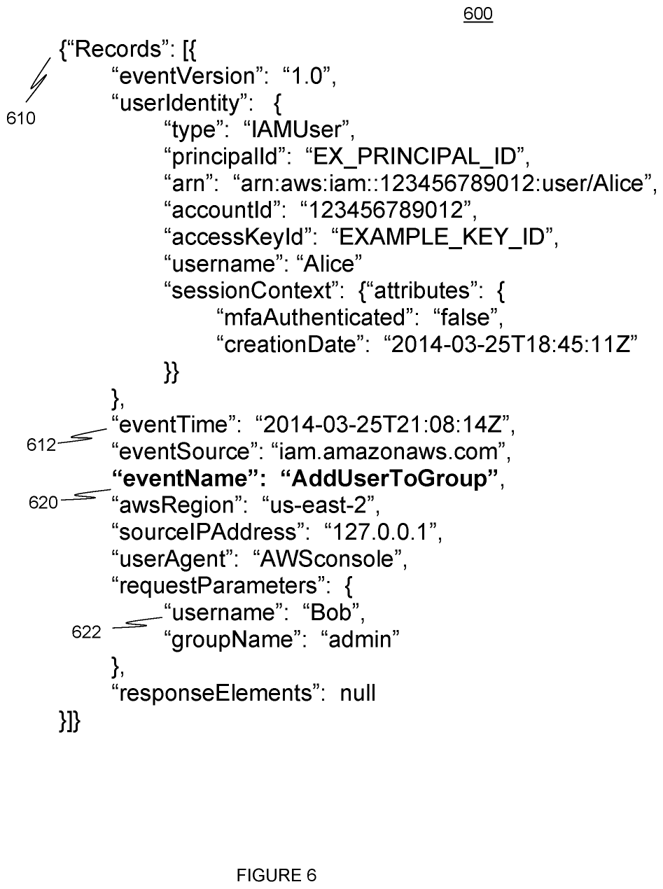

FIG. 6 is another example of a role log 600 of a cloud based computing environment, utilized to describe an embodiment. In an embodiment, a role log 400 includes a second record 610, which indicates that a user “Alice” which previously (based on the event time 612) created a user account “Bob”, added the user account “Bob” to an “Admin” group. The event name 620 indicates that the user account 622 was added to an admin group. Adding administrator accounts is not common, and if it is performed through a machine that includes a vulnerability, as explained herein, this may be an indication that the new administrator-level account is in fact an exploitation.

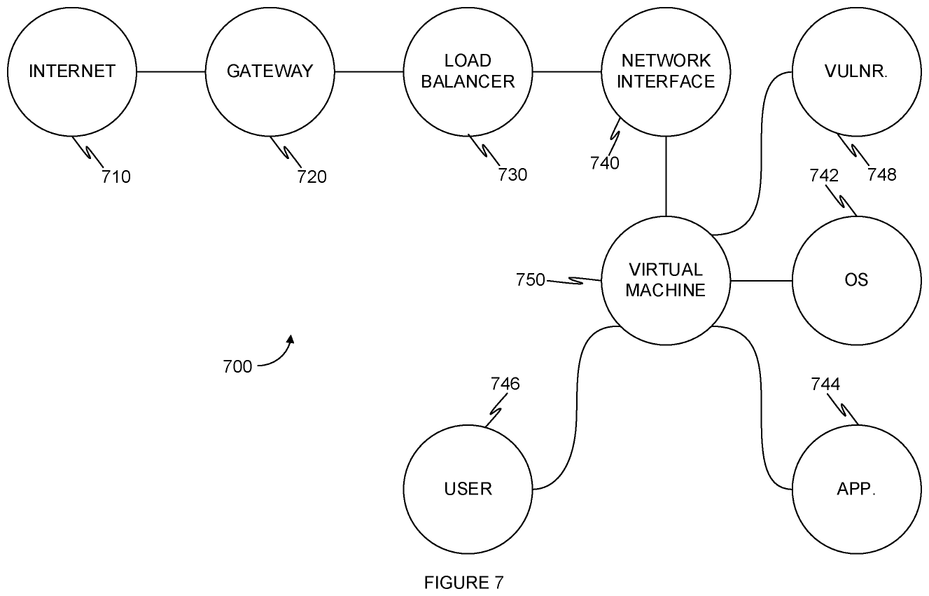

FIG. 7 is an example of a security graph 700, implemented in accordance with an embodiment. According to an embodiment, a security graph 700 represents a cloud computing environment, such as the production environment 110 of FIG. 1 above, in a graph database, according to a predefined data schema.

In an embodiment, a cloud computing environment is represented in a graph by mapping resources, principals, enrichments, and the like, to nodes in the security graph 700. In an embodiment, a node is generated in the security graph in response to detecting a cloud entity in a cloud computing environment. In certain embodiments, a resource node is generated to represent a resource, such as a workload. In some embodiments, a principal node is generated to represent a user account, a service account, a role, and the like. In an embodiment, an enrichment node is generated to represent an endpoint connection to a public network (e.g. internet), a vulnerability, an attribute of a workload, and the like.

According to an embodiment, an enrichment node 710 represents internet access, such that any node which is connected (e.g. by an edge) to the enrichment node 710, represents a workload which is able to access the internet. In an embodiment, a resource node 720 represents a gateway workload, which is implemented, for example, as a node in a software container cluster. A second resource node 730 represents a load balancer workload, which is connected by an edge to the gateway resource node 720 (representing a gateway resource), and a network interface node 740 (representing a network interface), according to an embodiment.

In an embodiment, the network interface node 740 is connected to a resource node 750 which represents a virtual machine, such as virtual machine 112 of FIG. 1. The virtual machine 112 includes, according to an embodiment, an operating system represented by OS node 742, an application which is executed on the OS of the virtual machine 112, represented by application node 744, a user account node 746 which represents a user account which is tied to the virtual machine 112, and a vulnerability node 748, which represents a vulnerability which was detected as being present on, or pertaining to, the virtual machine 112. A vulnerability is, for example, an outdated software, a specific open port, a user account with high (i.e., excessive) permissions, any combination thereof, and the like, according to an embodiment.

For example, in an embodiment, an inspector is configured to detect a vulnerability on a disk of the virtual machine 112. A node is generated to represent the virtual machine 112 in the security graph (i.e., resource node 750), a node is generated to represent the vulnerability (i.e., vulnerability node 748), and an edge is generated to connected the resource node 750 to the vulnerability node 748, thereby indicating that the virtual machine 112 includes the detected vulnerability.

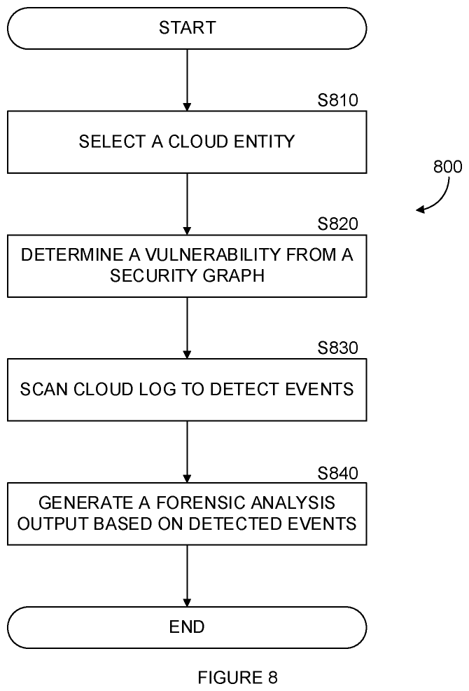

FIG. 8 is a flowchart of a method for generating a cloud detection and response (CDR) alert based on cloud log and a security graph, implemented in accordance with an embodiment.

At S810, a cloud log is accessed. In an embodiment a cloud log analyzer is configured to access a cloud log of a first cloud computing environment. In some embodiments, the cloud log is, for example, a network log, a role log, an event log, a combination thereof, and the like. In certain embodiments, the cloud log is accessed periodically, in response to a user request, a combination thereof, and the like.

In some embodiments, a plurality of cloud logs are accessed. In certain embodiments, a first cloud log is accessed from a first cloud computing environment, and a second cloud log is accessed from a second cloud computing environment.

In an embodiment, accessing a cloud log includes providing access to, for example by modifying a permission of, a principal such as a service account, a user account, and the like.

At S820, a cloud entity is extracted from the cloud log. In an embodiment, the cloud log analyzer is configured to extract the cloud entity. For example, in an embodiment, a log analyzer is configured to search a cloud log for predetermined keywords (such as “event”, “username”, etc.) and extract a value which is associated with the predetermined keyword (i.e., the cloud entity).

Extracting a cloud entity includes, according to an embodiment, detecting the cloud entity in the cloud log. A cloud entity is, in an embodiment, a workload type (e.g., a virtual machine, a software container, a serverless function, etc.), an application type (e.g., a software application, an appliance, an operating system, a gateway, a load balancer, etc.), a principal (e.g., a user account, a service account, etc.), an enrichment, a vulnerability, a combination thereof, and the like.

In an embodiment, the log analyzer is further configured to determine a relationship between a plurality of cloud entities. For example, in an embodiment, an event record includes an identifier of a virtual machine (workload type) that runs (relationship) a first application (application type) and has (relationship) a user account (principal) with (relationship) certain privileges and is connected to the internet (enrichment).

At S830, the security graph is traversed based on the cloud entity. In an embodiment, traversing the security graph based on the cloud entity includes detecting a node in the security graph having an attribute value which matches an identifier of the cloud entity. In an embodiment, a security graph may be traversed, for example by generating a query to detect a node based on matching an attribute of the cloud entity to an attribute of a node in the security graph. For example, a log analyzer is configured to query a security graph to detect nodes which match the selected cloud entity, based on the extracted cloud entity, according to an embodiment. Node attributes are, for example, a user account name, a role, a group, a workload type, an application type, ab operating system, an IP address, an authentication status, a combination thereof, and the like.

At S840, an alert is generated in response to determining that the node is associated with a threat. In an embodiment, the log analyzer is configured to generate the alert. In an embodiment, cloud entity represented by a node is associated with a threat, for example by determining that the node representing the cloud entity is connected to another node representing a cybersecurity threat, such as a known vulnerability, misconfiguration, exploitation, and the like.

In an embodiment, a misconfiguration is, for example, a database which is not password protected, and should be password protected. A vulnerability on a workload, for example, is not necessarily exploited, or even exploitable, in some embodiments. As an example, in an embodiment, a workload has a vulnerability which allows broad access if exploited, however where the workload is not accessible by an external network, then the vulnerability is not exploitable. It is therefore beneficial to utilize a cloud log to determine if a vulnerability was exploited, for example based on detecting a record indicating an exploit in a cloud log.

In some embodiments, a report is generated which includes an identifier of the cloud entity, a record from the cloud log corresponding to the identifier, a matched node (i.e., an identifier of a node detected in the security graph which matches the identifier of the cloud entity), a combination thereof, and the like.

For example, in an embodiment, a first cloud entity is an unknown user (e.g., user from outside an organization) which is accessing a second cloud entity, such as a database resource. Such an access is recorded as a data record in a cloud log. In an embodiment, the security graph is traversed to detect a node corresponding to the database resource. In certain embodiments, the database resource is found to be misconfigured (e.g., not having a password), and an alert is generated in response to detecting that the database resource includes a cybersecurity threat.

For example, in an embodiment, a node representing the database resource is connected to a node representing a misconfiguration of a type indicating that a database is not secured. In some embodiments, the generated alert includes the record which indicated that the unknown user accessed the database resource.

In certain embodiments, generating an alert based on actual detected exploitation is advantageous, as a vulnerability which is exploited needs to be addressed faster than a vulnerability which is only potentially exploitable.

At S850, a mitigation action is initiated. In an embodiment, a mitigation action includes revoking network access to a resource, revoking network access from a resource, modifying a permission of a principal, generating a ticket corresponding to the alert in a ticketing system, initiating an instruction to update a software on a resource, a combination thereof, and the like. In certain embodiments, the mitigation action is generated based on a detected cybersecurity threat, a determined policy violation, a combination thereof, and the like.

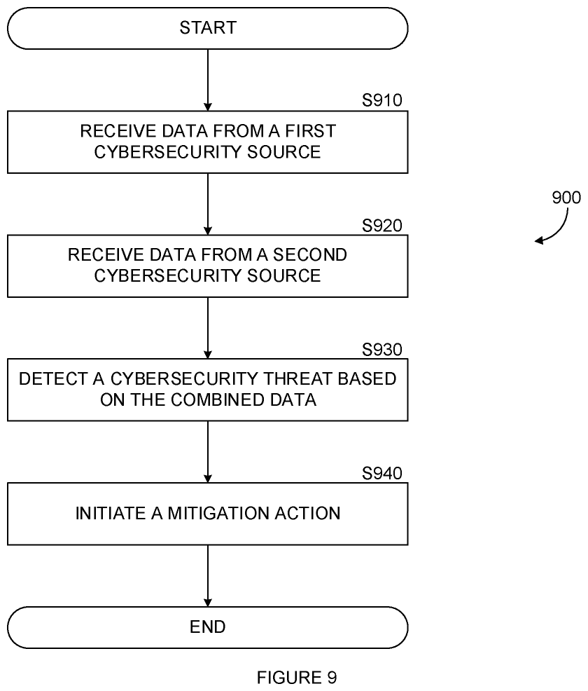

FIG. 9 is an example flowchart of a method for detecting a cybersecurity threat based on multiple information sources, implemented in accordance with an embodiment.

At S910, data is received from a first cybersecurity source. In an embodiment, the first cybersecurity source is an inspector, a log analyzer, a sensor, a combination thereof, and the like. In some embodiments the data includes an event, an event record, a file, a hash, an identifier of a resource, an identifier of a principal, a timestamp, a combination thereof, and the like.

For example, in an embodiment, the first cybersecurity source is an inspector, which provides cybersecurity findings. A finding is a positive determination that a cybersecurity object, which the inspector is configured to detect, has been detected on a resource which the inspector was configured to inspect.

In some embodiments, receiving data from a first cybersecurity source is not indicative of a cybersecurity event. For example, it is not uncommon for resources to have known vulnerabilities. Even when a patch, fix, and the like exist to solve a known vulnerability, such a software patch is not always installed immediately on, for example, a virtual machine, since the software patch requires testing to ensure that a machine with the software patch installed performs as expected.

It is disadvantageous, in certain embodiments, to immediately install such a software patch in a production environment without first determining that the software patch does not interfere with other services, processes, and the like, which are executed on the virtual machine.

Therefore, in certain embodiments, an indicator such as presence of a vulnerability, generation of a new principal, generation of a new process, initiation of a new service, changing permissions of a principal, and the like, do not by themselves indicate that a cybersecurity event is occurring or has occurred.

At S920, data is received from a second cybersecurity source. In an embodiment, the second cybersecurity source is a source type which is different from the first cybersecurity source type. For example, in an embodiment, the first cybersecurity source is an inspector, and the second cybersecurity source is a sensor.

In some embodiments, data is received from a plurality of cybersecurity sources. In such embodiments, at least a first cybersecurity source is of a different type than a second cybersecurity source.

In certain embodiments, data from the first cybersecurity source, data from the second cybersecurity source, and the like, are stored in a graph database, for example on a security graph. In some embodiments, the security graph is traversed to detect a node corresponding, for example, to a resource deployed in a computing environment, that has stored thereon data from a plurality of cybersecurity sources.

At S930, a cybersecurity threat is detected based on combined data. In an embodiment, combined data includes data received from the first cybersecurity source, and data received from the second cybersecurity source.

In an embodiment, a cybersecurity threat, a cybersecurity event, and the like, is detected by applying a rule to an event, a data record, and the like, received from the plurality of cybersecurity sources. For example, where a first event is detected from a first cybersecurity source, a rule, a policy, and the like, are applied to the first event.

In an embodiment, applying the rule configures an inspection controller to detect from a second cybersecurity source, a second event, a second cybersecurity object, a combination thereof, and the like. Where the second event, second cybersecurity object, and the like, is detected, a cybersecurity event is determined to have been detected.

In some embodiments, detecting a first event, a first cybersecurity object, and the like, from a first cybersecurity source, configure an inspection controller to detect a second event, second cybersecurity object, and the like, from a second cybersecurity source.

In certain embodiments, the inspection controller is configured to access a plurality of policies. In an embodiment, a policy includes, for example, a conditional rule which specifies that a predetermined action should be initiated with respect to a second cybersecurity source, in response to detecting a first event from a first cybersecurity source.

For example, in an embodiment, a sensor is configured to query a cloud API, instance metadata service (IMDS), and the like, to detect an identifier of a resource on which the sensor is deployed. In certain embodiments, the sensor is further configured to send an event, the detected identifier, a combination thereof, and the like, to the sensor backend server. In some embodiments, the sensor backend server is configured to receive the detected identifier and generate a query for a graph database, for a log analyzer, a combination thereof, and the like, to detect events, for example in a log accessible by the log analyzer. In such an embodiment, the sensor is a first cybersecurity source, and the log is a second cybersecurity source.

At S940, a mitigation action is initiated. In an embodiment, the mitigation action includes generating an instruction to inspect a resource in the computing environment. In some embodiment, the mitigation action includes generating an instruction to inspect a plurality of resources in the computing environment. For example, a plurality of resources includes, according to an embodiment, a resource which has indicators from a plurality of cybersecurity sources for a cybersecurity event, and at least another resource which is connected to the resource.

According to some embodiments, a security graph is traversed to detected a node representing the resource, and another node connected to the node representing the resource, to detect the at least another resource and initiate inspection thereon.

In some embodiments, the mitigation action includes sandboxing the resource on which the cybersecurity event is detected, revoking network access to the resource, revoking network access from the resource, generating an alert, generating a severity score for an alert, generating a notification, initiating inspection of a resource, generating a ticket, modifying a severity score of a ticket, a combination thereof, and the like.

In certain embodiments, the sensor is assigned a memory portion of a workload on which it is deployed. In certain embodiments, the memory portion is utilized by the sensor as a buffer, including events stored in the buffer. In certain embodiments, the mitigation action includes sending the contents of the buffer, a portion of the contents of the buffer, and the like, for example to the sensor backend server.

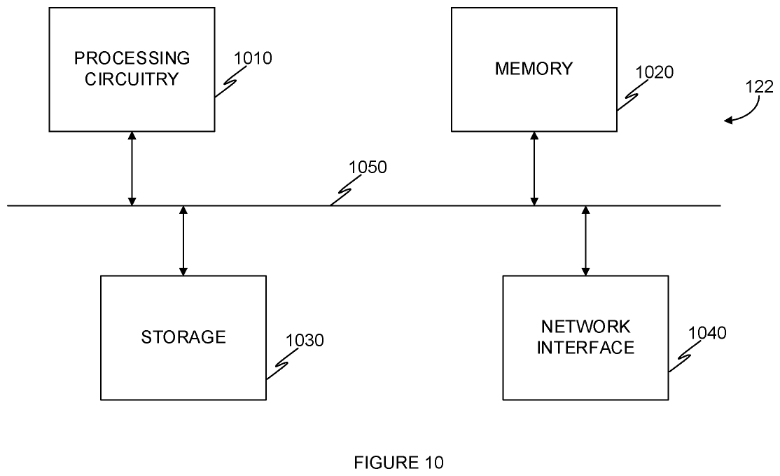

FIG. 10 is an example schematic diagram of an inspection controller 122 according to an embodiment. The inspection controller 122 includes a processing circuitry 1010 coupled to a memory 1020, a storage 1030, and a network interface 1040. In an embodiment, the components of the inspection controller 122 may be communicatively connected via a bus 1050.

The processing circuitry 1010 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 1020 may be volatile (e.g., random access memory, etc.), non-volatile (e.g., read only memory, flash memory, etc.), or a combination thereof. In an embodiment, the memory 1020 is an on-chip memory, an off-chip memory, a combination thereof, and the like. In certain embodiments, the memory 1020 is a scratch-pad memory for the processing circuitry 1010.

In one configuration, software for implementing one or more embodiments disclosed herein may be stored in the storage 1030, in the memory 1020, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 1010, cause the processing circuitry 1010 to perform the various processes described herein.

The storage 1030 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 1040 is configured to provide the inspection controller 122 with communication with, for example, the inspector 124, the log analyzer 132, the graph database 126, and the sensor backend server 128.

It should be understood that the embodiments described herein are not limited to the specific architecture illustrated in FIG. 10, and other architectures may be equally used without departing from the scope of the disclosed embodiments.

Furthermore, in certain embodiments the inspector 124, the graph database 126, the log analyzer 132, the sensor backend server 128, a combination thereof, and the like, may be implemented with the architecture illustrated in FIG. 10. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for detecting a cybersecurity event based on multiple cybersecurity data sources, comprising:
receiving data from a first cybersecurity source, the first cybersecurity source configured to generate data based on a resource deployed in a computing environment;
receiving data from a second cybersecurity source, the second cybersecurity source configured to generate data based on the resource deployed in the computing environment, wherein the second cybersecurity source has a source type which is different from a source type of the first cybersecurity source;
detecting a cybersecurity event on the resource based on data received from the first cybersecurity source and data received from the second cybersecurity source; and
initiating a mitigation action for the resource in response to detecting the cybersecurity event.

2. The method of claim 1, further comprising:
receiving data from a plurality of cybersecurity sources, wherein at least a first cybersecurity source is of a first type, and a second cybersecurity source is of a second type which is different from the first type.

3. The method of claim 1, further comprising:
storing the received data in a graph database, the graph database including a security graph having stored therein a representation of the computing environment.

4. The method of claim 1, further comprising:
applying a policy to data received from the first cybersecurity source; and
generating an instruction to receive data from the second cybersecurity source in response to triggering a rule of the policy.

5. The method of claim 1, further comprising:
detecting an event in the data received from the first cybersecurity source; and
detecting a cybersecurity object in the data received from the second cybersecurity source.

6. The method of claim 5, wherein the cybersecurity object is any one of: a file, a file system, a hash, a password, a certificate, an encryption key, a malware object, and a combination thereof.

7. The method of claim 1, wherein the mitigation action includes any one of:
sandboxing the resource on which the cybersecurity event is detected, revoking network access to the resource, revoking network access from the resource, generating an alert, generating a severity score for an alert, generating a notification, initiating inspection of a resource, and any combination thereof.

8. The method of claim 1, further comprising:
initiating inspection of the resource in response to detecting the cybersecurity event.

9. The method of claim 1, wherein the received data includes any one of: an event record, a file, a hash, an identifier of a resource, an identifier of a principal, a timestamp, and any combination thereof.

10. A non-transitory computer-readable medium storing a set of instructions for detecting a cybersecurity event based on multiple cybersecurity data sources, the set of instructions comprising:
one or more instructions that, when executed by one or more processors of a device, cause the device to:
receive data from a first cybersecurity source, the first cybersecurity source configured to generate data based on a resource deployed in a computing environment;
receive data from a second cybersecurity source, the second cybersecurity source configured to generate data based on the resource deployed in the computing environment, wherein the second cybersecurity source has a source type which is different from a source type of the first cybersecurity source;
detect a cybersecurity event on the resource based on data received from the first cybersecurity source and data received from the second cybersecurity source; and
initiate a mitigation action for the resource in response to detecting the cybersecurity event.

11. A system for detecting a cybersecurity event based on multiple cybersecurity data sources comprising:
a processing circuitry; and
a memory, the memory containing instructions that, when executed by the processing circuitry, configure the system to:
receive data from a first cybersecurity source, the first cybersecurity source configured to generate data based on a resource deployed in a computing environment;
receive data from a second cybersecurity source, the second cybersecurity source configured to generate data based on the resource deployed in the computing environment, wherein the second cybersecurity source has a source type which is different from a source type of the first cybersecurity source;
detect a cybersecurity event on the resource based on data received from the first cybersecurity source and data received from the second cybersecurity source; and
initiate a mitigation action for the resource in response to detecting the cybersecurity event.

12. The system of claim 11, wherein the memory contains further instructions which when executed by the processing circuitry further configure the system to:
receive data from a plurality of cybersecurity sources, wherein at least a first cybersecurity source is of a first type, and a second cybersecurity source is of a second type which is different from the first type.

13. The system of claim 11, wherein the memory contains further instructions which when executed by the processing circuitry further configure the system to:
store the received data in a graph database, the graph database including a security graph having stored therein a representation of the computing environment.

14. The system of claim 11, wherein the memory contains further instructions which when executed by the processing circuitry further configure the system to:
apply a policy to data received from the first cybersecurity source; and
generate an instruction to receive data from the second cybersecurity source in response to triggering a rule of the policy.

15. The system of claim 11, wherein the memory contains further instructions which when executed by the processing circuitry further configure the system to:
detect an event in the data received from the first cybersecurity source; and
detect a cybersecurity object in the data received from the second cybersecurity source.

16. The system of claim 15, wherein the cybersecurity object is any one of: a file, a file system, a hash, a password, a certificate, an encryption key, a malware object, and a combination thereof.

17. The system of claim 11, wherein the mitigation action includes any one of: sandboxing the resource on which the cybersecurity event is detected, revoking network access to the resource, revoking network access from the resource, generating an alert, generating a severity score for an alert, generating a notification, initiating inspection of a resource, and any combination thereof.

18. The system of claim 11, wherein the memory contains further instructions which when executed by the processing circuitry further configure the system to:
initiate inspection of the resource in response to detecting the cybersecurity event.

19. The system of claim 11, wherein the received data includes any one of: an event record, a file, a hash, an identifier of a resource, an identifier of a principal, a timestamp, and any combination thereof.
